(19) United States
(12) Patent Application Publication
(10) Pub. No.: US 2010/0157577 A1
(43) Pub. Date: Jun. 24, 2010

(54) BACKLIGHT AND DISPLAY

(75) Inventors: David James Montgomery, Oxford (GB); Florian Gilles Pierre Rocard, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(73) Assignee: SHARP KABUSHIKI KAISHA, Osaka (JP)

(21) Appl. No.: 12/515,134

(22) PCT Filed: Nov. 7, 2007
(86) PCT No.: PCT/JP2007/072055

§ 371 Date: Nov. 30, 2009

(30) Foreign Application Priority Data
Nov. 20, 2006 (GB) 0622990.0

(51) Int. Cl. G02F 1/13357

(52) U.S. Cl. 362/97.2

(57) ABSTRACT

A backlight is provided for a transmissive spatial light modulator such as a liquid crystal device (1). The backlight comprises a light source (5), which supplies light through an input edge surface (12) of a non-flat light guide (4) having a front surface (4a) and a rear surface (4b). The rear surface (4b) comprises a plurality of concave features (10), each of which has a surface (11) which faces the input surface (12) and which is oriented so as to direct light towards and out of the front surface (4a). The surfaces (11) have slope angles with respect to a tangent plane to the rear surface (4b) at the feature (10) which vary with distance from the input surface (12) so as to concentrate output light from the light guide (4) into a desired angular output range.

### TECHNICAL FIELD

The present invention relates to a backlight for an at least partially transmissive spatial light modulator. The present invention also relates to a display including such a backlight.

### BACKGROUND ART

U.S. Pat. No. 4,616,295 (Hewlett Packard) describes a basic light-guide for display illumination (FIG. 1). It consists of a flat slab-type light-guide with two mounted fluorescent tubes, one at each end. The light-guide has “frosting” by which the light is coupled out. This does not disclose the nature of the “frosting”.

U.S. Pat. No. 6,904,225 (Nichia) describes a pattern for the features that frustrate total internal reflection in the light-guide. This pattern is specific to point-like illuminators, such as LEDs, that do not illuminate evenly along the edge. This pattern increases the feature density between LEDs and decreases it near them to improve uniformity.

JP 2006/066282 (Sharp) describes a flat slab-type light-guide with a fluorescent tube positioned at opposite ends. Linear triangular grooves are cut into the lower surface of the light-guide. One side of the grooves, towards one fluorescent tube is diffusive and the other plane refractive. With one fluorescent tube on, largely the diffusive side is illuminated allowing a wide emission angle. With the other on, the refractive side is illuminated producing a narrower angle.

JP 2002/131555 (Koike) describes a slab-type light-guide with two fluorescent tubes, one at each end, that illuminate the light-guide. The light-guide consists of a uniform scattering medium that disrupts total internal reflection and linear triangular structures on the top surface of the light-guide change the emission angle of the scattered light. The triangular structures are not taught to out-couple the light from the light-guide, and the “uniform” scattering arrangement of the light-guide would not in any case give a very good uniform emission.

JP 2001/332112 (Mitsubishi) describes a slab-type light-guide and scatter features that could constitute wedge shaped, trapezoidal or triangular structures. This could also be applied to one or two illuminating fluorescent tubes. The structures control the out-coupling of the light but do not control the directionality of the light. The features are also in a regular pattern (which could in principle be seen without sufficient diffusion above the light-guide) and their size changes with position to change the efficiency of out-coupling to maintain uniformity. The problem of a large difference in the sizes of features is that they must be individually cut in a different way during manufacture. This may be costly and time consuming to set up.

U.S. Pat. No. 6,761,461 & U.S. Pat. No. 6,786,613 (Minebea) describe a slab-type light-guide for use with a fluorescent tube illuminator. The scatter features are of a slanted triangular shape and are modified to improve viewing angle and directionality. The features however, are grooves and not separate features. Also, the size of the feature, and not the shape or distribution, is changed with position to effect changes in scattering efficiency.

U.S. Pat. No. 6,211,929 (Enplas) describes a tapered-type light-guide with side face illuminator and reflector positioned beneath this light-guide. The reflector is constructed with scattering regions. This with a proper design of the front backlight face can control directionality of the light. The backlight face may be prisms or be a separate prism sheet. This involves separate reflector features.

U.S. Pat. No. 6,667,782 (IBM) describes a backlight system for directional control. This backlight system consists of a fluorescent illuminator. There is also a tapered-type light-guide, placed on the lower face of which is a refractive layer. Underneath this is another refractive layer whose interface is grooved and acts as a reflector. This involves separate reflector features and refractive layers.

JP 2004/288570 (Toshiba) describes a slab light-guide that has been curved along with fluorescent and LED light sources. Extraction features are limited to a light control plate or volume scattering features within the light-guide.

FIG. 1 of the accompanying drawings illustrates a typical display of known type as used in small mobile devices, such as mobile or “cellular” telephones and personal digital assistants, and medium sized apparatuses such as laptop computers or monitor devices. The display comprises a flat transmissive spatial light modulator (SLM) in the form of a liquid crystal display (LCD) panel 1 having input and output polarisers 2 and 3. The panel 1 is provided with a backlight whose main components are a light guide 4, a light source or illuminator 5, a rear reflector 6, a diffuser 7 and a pair or orthogonally oriented brightness enhancement films 8 and 9.

The light guide has an area or “size” in a plane perpendicular to the plane of FIG. 1 at least as big as the display area of the panel 1 with a thickness much less than its other dimensions. The light guide 4 shown in FIG. 1 is of the “slab” type, where its thickness is substantially the same across the whole of its area. However, it is also known for the light guide 4 to be of the “tapered” type with a thickness which typically decreases linearly away from the light guide edge surface immediately facing the illuminator 5.

The backlight shown in FIG. 1 comprises a single illuminator 5 disposed along one edge of the light guide 4, which is typically rectangular in plan view. However, illuminators may be provided along more than one edge surface and a known arrangement provides illuminators along opposite edges of the light guide 4. The or each illuminator 5 typically comprise a cold cathode fluorescent lamp (CCFL) or a plurality of light emitting diodes (LEDs) distributed along one or more of the light guide edges.

The reflector 6 is disposed behind the light guide 4 but not in contact with it and is typically a high efficiency specular, or diffuse specular reflector. The reflector 6 returns light leaking from the rear surface of the light guide 4 back into the light guide so as to improve efficiency of light utilisation.

The diffuser 7 is intended to improve the uniformity of light output and to provide a wider viewing angle range than would be possible without the diffuser. Typically, the display will be intended to be viewed “on-axis” in a direction which is substantially normal to the display surface of the panel 1. The enhancement films 8 and 9 are arranged to redirect light towards the display normal or axis and are typically in the form of lenticular prism layers with the prisms being oriented in orthogonal directions.

The light guide 4 is provided with extraction features illustrated diagrammatically at 10 on the rear surface of the light guide. However, such features may be provided on the front surface or on both surfaces of the light guide 4. Such features are typically in the form of spots, scratches or diffusive regions on either or both major surfaces of the light guide 4 and serve to disrupt total internal reflection (TIR) within the light guide 4 so as to couple light out of the front surface of the light guide 4 towards the panel 1. The features 10 are generally arranged to provide reasonably uniform light output from the front surface but the output light is generally not sufficiently uniform in the appropriate direction for use directly with the panel 1 so that the diffuser 7 and the enhancement films 8 and 9 are essential.

FIG. 2 of the accompanying drawings illustrates the light-directing performance of a typical guide 4 with typical extraction features 10 so as to illustrate the need for the diffuser 7 and the enhancement films 8 and 9. In particular, the graph of FIG. 2 shows light emission from the light guide 4 in arbitrary units for a range of typical feature sizes against angle of emission in degrees with the orientation illustrated below the graph. Thus, the typical scattering features 10 cause light to be coupled out of the light guide 4 with a majority of the light exiting around an angle of 40° to the normal to the output or front surface of the light guide 4. Such performance is generally unacceptable and requires the presence of the diffuser 7 and the enhancement films 8 and 9.

### DISCLOSURE OF THE INVENTION

According to a first aspect of the invention, there is provided a backlight for an at least partially transmissive spatial light modulator, comprising at least one first light source and a non-flat light guide having a front major surface for outputting light, a rear major surface, and a first minor surface for inputting light from the at least one first light source, the front surface being non-flat in that it is non-planar such that it cannot be contained in a single plane, at least one of the front and rear surfaces having a plurality of concave features, each of which is defined by a plurality of surfaces extending into the light guide from the major surface, each concave feature of a first set thereof having a first substantially flat surface facing the first minor surface and having a first slope angle, with respect to a tangent plane to the major surface at the feature, oriented to reflect light originating from the at least one first light source out of the light guide, at least one feature of the first set having a first slope angle which is different from that of at least one other feature of the first set.

The rear surface may have at least some of the features. The rear surface may have all of the features. The first surfaces of the features of the rear surface may be oriented to reflect the light towards and through the front surface.

The at least one feature and the at least one other feature may be at different distances from the first minor surface.

The tangent planes at the at least one feature and at the at least one other feature may be non-parallel.

The first slope angles may be arranged to reduce the angular spread of light leaving the front surface.

The rear surface may be substantially totally internally reflecting for most of the light originating from the at least one first light source.

The light guide may have at least one first section whose front surface is concave and whose rear surface is convex. The front and rear surfaces of the at least one first section may be cylindrical. The at least one other feature may be further from the first minor surface and may have a smaller first slope angle than the at least one feature.

The light guide may have at least one second section whose front surface is convex and whose rear surface is concave. The front and rear surfaces of the at least one second section may be cylindrical. The at least one other feature may be further from the first minor surface and may have a larger first slope angle than the at least one feature.

The light guide may have at least one third flat section.

The first slope angle may vary with feature distance from the first minor surface.

The concave features may be arranged to direct light leaving the light guide in substantially the same direction with respect to the light guide. As an alternative, the concave features may be arranged as first and second groups distributed across the light guide and arranged to direct light leaving the light guide substantially in first and second different directions, respectively, with respect to the light guide.

The light guide may be of substantially constant thickness. As an alternative, the light guide may have a thickness which reduces with distance from the first minor surface.

The backlight may comprise at least one second light source, the light guide having a second minor surface for inputting light from the at least one second light source. The first and second minor surfaces may comprise facing edge surfaces of the light guide. Each of a second set of the features may have a second substantially flat surface facing the second minor surface and having a second slope angle, with respect to the tangent plane to the major surface at the feature, oriented to reflect light originating from the at least one light source out of the light guide, at least one feature of the second set having a second slope angle which is different from that of at least one other feature of the second set.

The at least one feature and the at least one other feature of the second set may be at different distances from the second minor surface.

The tangent planes at the at least one feature and the at least one other feature of the second set may be non-parallel.

The second slope angles may be arranged to reduce the angular spread of light leaving the front surface.

For a light guide having at least one first section whose front surface is concave and whose rear surface is convex, the at least one other feature of the second set may be further from the second minor surface and may have a smaller second slope angle than the at least one feature of the second set.

For a light guide having at least one second section whose front surface is convex and whose rear surface is concave, the at least one other feature of the second set may be further from the second minor surface and may have a larger second slope angle than the at least one feature of the second set.

The second slope angle may vary with feature distance from the second minor surface.

The second set may comprise all of the features.

The first set may comprise all of the features.

The features may have the same footprints in the major surface.

The surface density of the first surfaces may increase with distance from the first minor surface.

The surface density of the second surfaces may increase with distance from the second minor surface.

According to a second aspect of the invention, there is provided a display comprising a backlight according to the first aspect of the invention and an at least partially transmissive spatial light modulator.

The modulator may be a liquid crystal device.

The display may comprise a single brightness enhancing film disposed between the backlight and the modulator.

It is thus possible to provide a non-flat backlight whose angular light spread may be controlled so as to improve the desired viewing angle range of a display. This permits the use of a weaker diffuser and removes the need for any other brightness enhancing techniques in a plane in which the backlight is non-flat. In some applications, it may be possible to omit both of the conventionally used enhancement films. Thus, it is possible to provide a thinner backlight of lower cost.

Further, no special brightness enhancement film structure is needed. In the case where a single film is provided, this may be of a conventional type. Such an arrangement allows non-flat displays to be provided with good viewing angle performance and of reduced thickness and cost.

In this context, the term “non-flat” when referred to a light guide or a display means a device having at least an output surface which is non-planar, so that it cannot be contained in a single plane. In general, light guides and display panels are relatively thin with opposing surfaces which are typically of the same or similar profile. When referring to a light guide, at least the output surface is non-flat in the sense that it cannot be contained in a single plane and generally the rear surface will follow a similar “parallel” shape to give substantially constant thickness or a relatively gently tapering thickness. Thus, displays of the type shown in FIG. 1 are flat because the output or image surface of the panel 1 is flat in the sense that it can be contained in a single plane. Similarly, the light guide 4 shown in FIG. 1 is flat because its output surface can similarly be contained in a single plane.

The present invention is exclusively concerned with non-flat light guides for use with non-flat, generally correspondingly profiled, display devices. The light guide may be continuously curved in one or two dimensions or may comprise a plurality of sections, at least some of which may be flat. Indeed, all of the sections may be flat so long as they are not co-planar and are not parallel.

The terms “concave” and “convex” are used herein in their most general meanings, unless the context requires otherwise. In particular, “concave” refers to bulging inwardly whereas “convex” refers to bulging outwardly. The surfaces defining such bulges may be continuously curved or may be facetted with curved and/or flat facets or surfaces.

### BRIEF DESCRIPTION OF DRAWINGS

FIG. 1 is a diagrammatic cross-sectional view of a known type of display and backlight;

FIG. 2 is a graph of light output against angle of emission for a light guide of the display shown in FIG. 1;

FIG. 3 is a diagrammatic cross-sectional view of a display and backlight constituting an embodiment of the invention;

FIGS. 4 and 5 are diagrammatic cross-sectional views of extraction features of the light guide of FIG. 3;

FIG. 6 is a diagrammatic view illustrating the general shape and footprint of the extraction features;

FIG. 7 is a graph of light output against angular direction for different slope angles of extraction features;

FIG. 8 is a diagrammatic cross-sectional view of an illuminator and light guide which may be used in a display and backlight of the type shown in FIG. 3;

FIG. 9 is a diagrammatic cross-sectional view of illuminators and a light guide which may be used in a display of the type shown in FIG. 3;

FIG. 10 is a diagrammatic cross-sectional view of illuminators and a light guide which may be used in a display and backlight of the type shown in FIG. 3;

FIG. 11 is a diagrammatic cross-sectional view of a display and backlight constituting an embodiment of the invention;

FIG. 12 is a diagrammatic cross-sectional view of an illuminator and light guide which may be used in a display and backlight of the type shown in FIG. 3;

FIG. 13 is a diagrammatic cross-sectional view of an illuminator and light guide which may be used in a display and backlight of the type shown in FIG. 3;

FIG. 14 is a diagrammatic cross-sectional view of an illuminator and light guide which may be used in a display and backlight of the type shown in FIG. 3;

FIG. 15 is a diagrammatic cross-sectional view of an illuminator and light guide which may be used in a display and backlight of the type shown in FIG. 3;

FIG. 16 is a diagrammatic cross-sectional view of an illuminator and light guide which may be used in a display and backlight of the type shown in FIG. 3; and

FIG. 17 is a diagrammatic cross-sectional view of an illuminator and light guide which may be used in a display and backlight of the type shown in FIG. 3.

### BEST MODE FOR CARRYING OUT THE INVENTION

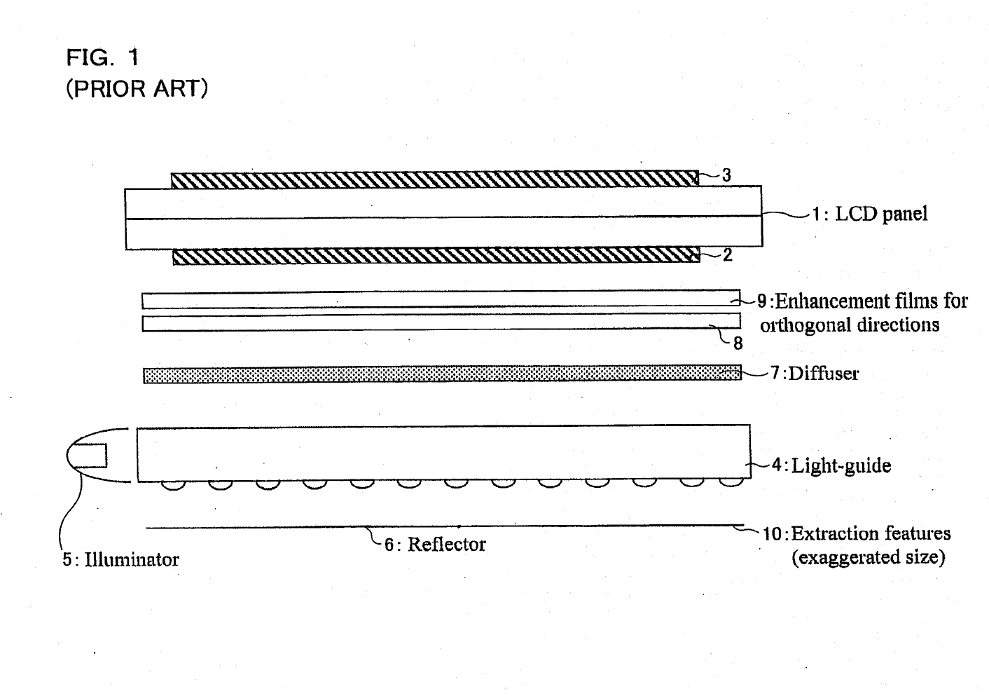

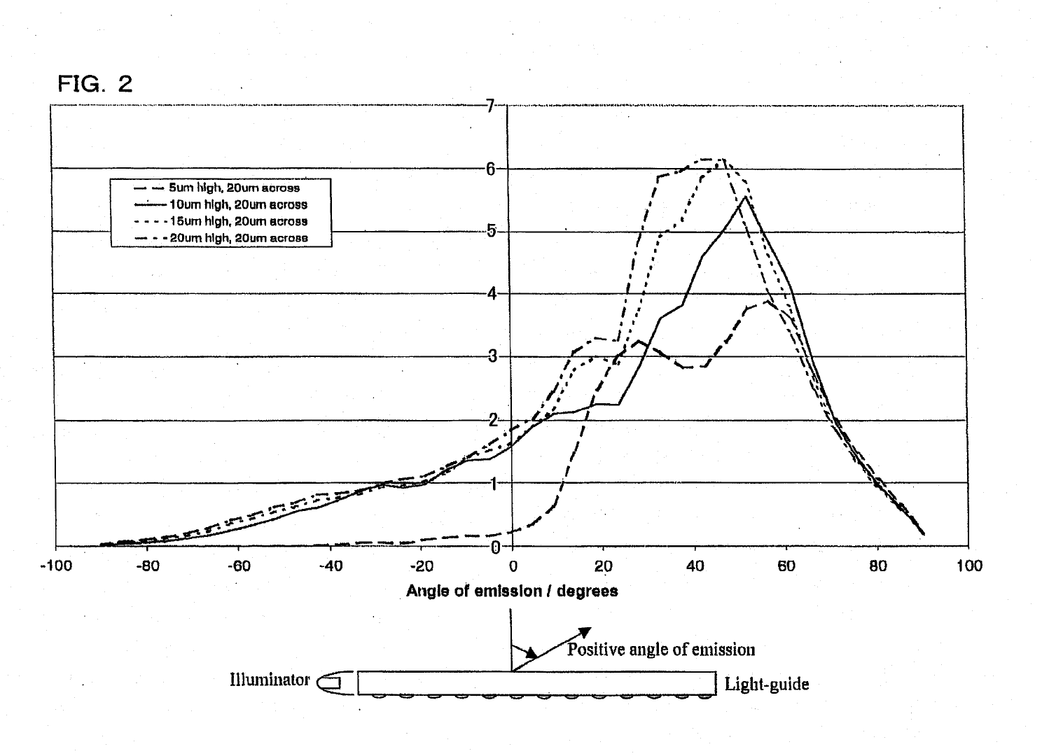

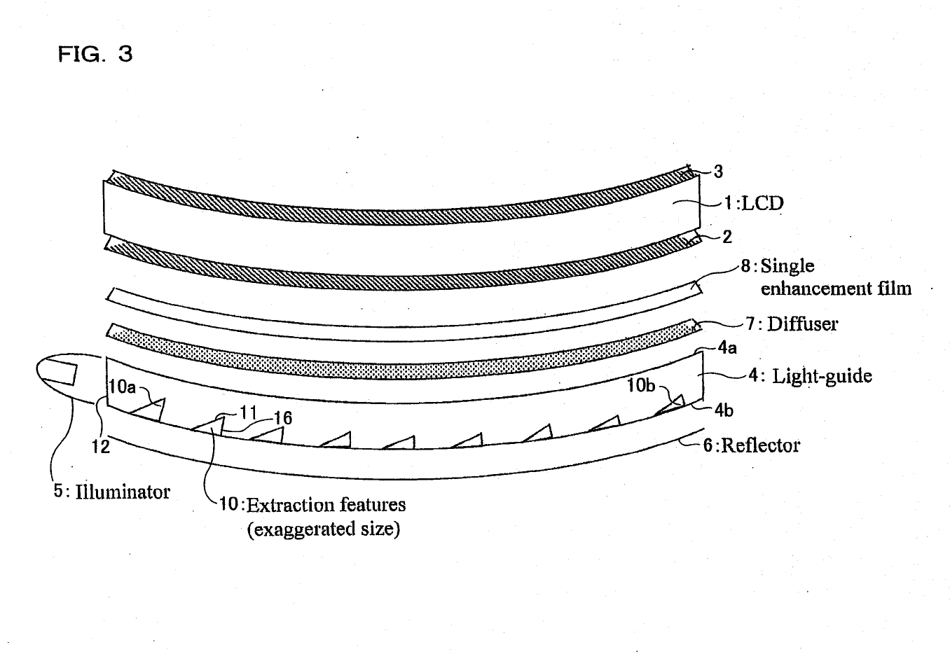

FIG. 3 illustrates a display which differs primarily from that shown in FIG. 1 in that the display is non-flat. In particular, in this embodiment, the display is curved about a single axis which is perpendicular to the plane of the drawing. Thus, the LCD 1 has an output surface which is cylindrically curved and is of substantially constant thickness. The input and output polarisers 2 and 3 are correspondingly curved, as are the light guide 4, the reflector 6, the diffuser 7 and the enhancement film 8. The display of FIG. 3 further differs in that the diffuser 7 is a weaker diffuser than that required in FIG. 1 and only a single enhancement film 8 is required. Further, the structure of the light guide 4 in FIG. 3 differs from that shown in FIG. 1. The display is concave in the sense that the image plane is concave when viewed from the viewing region in front of the display.

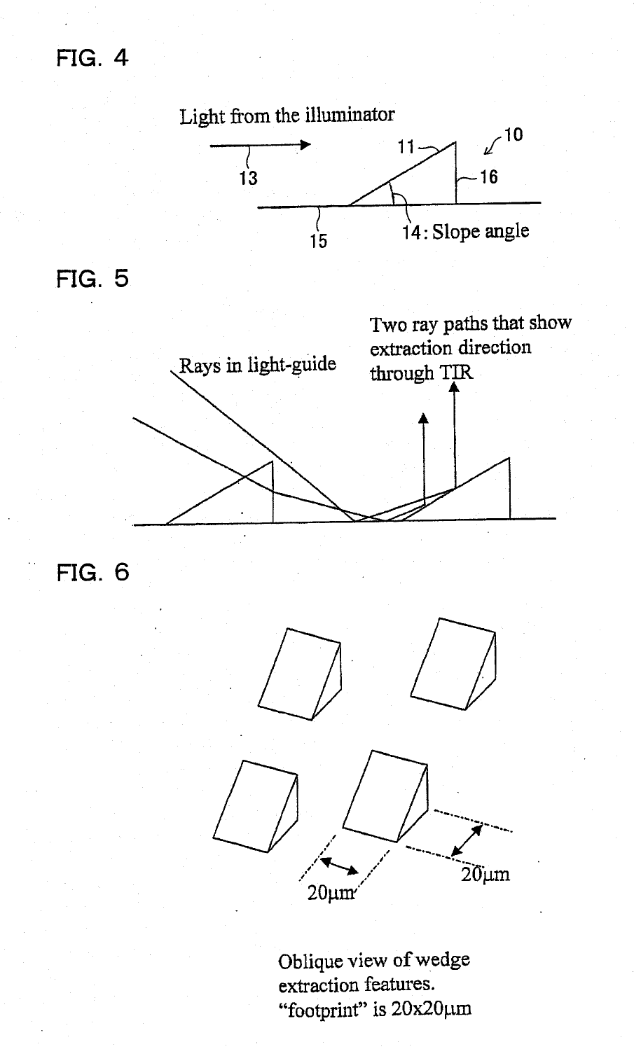

As shown to an exaggerated scale in FIG. 3, the extraction features 10 are concave features in the rear surface of the light guide 4. As shown in FIG. 4, each feature 10 has a first surface 11 which faces the light input edge surface 12 of the light guide 4 so that light propagating through the light guide 4 in the general direction 13 from the illuminator 5 travels generally towards the first surface 11. The first surface 11 makes a slope angle shown at 14 with the tangent plane 15 to the rear surface of the light guide 4 at the feature 10. Each feature 10 has a second surface 16 which, in this embodiment, is in a plane substantially orthogonal to the tangent plane 15. However, the second surfaces 16 may have other orientations, for example chosen for convenience of manufacture.

As shown in FIG. 5, the features 10 control the total internal reflection from the surfaces 11 so that light which has undergone a reflection from the rear surface of the light guide is then reflected towards and out of the front surface. The surfaces of the features 10, like the other surfaces of the light guide 4, are refractive surfaces and reflection from these surfaces results from total internal reflection. No special surface treatment is necessary in order to the make the surfaces such as 11 reflective.

FIG. 6 illustrates the shape of such features, which have a typical “foot print” on the rear surface of the light guide 4 which is square and of the same size throughout the light guide. In this example, the footprint of each feature is a 20 micrometre square. The features 20 are shown as being arranged in a regular pattern but may alternately be arranged in some other way, such as in a random or pseudo-random pattern or as lenticules. The features have a surface density for achieving a more uniform or desirable light output distribution.

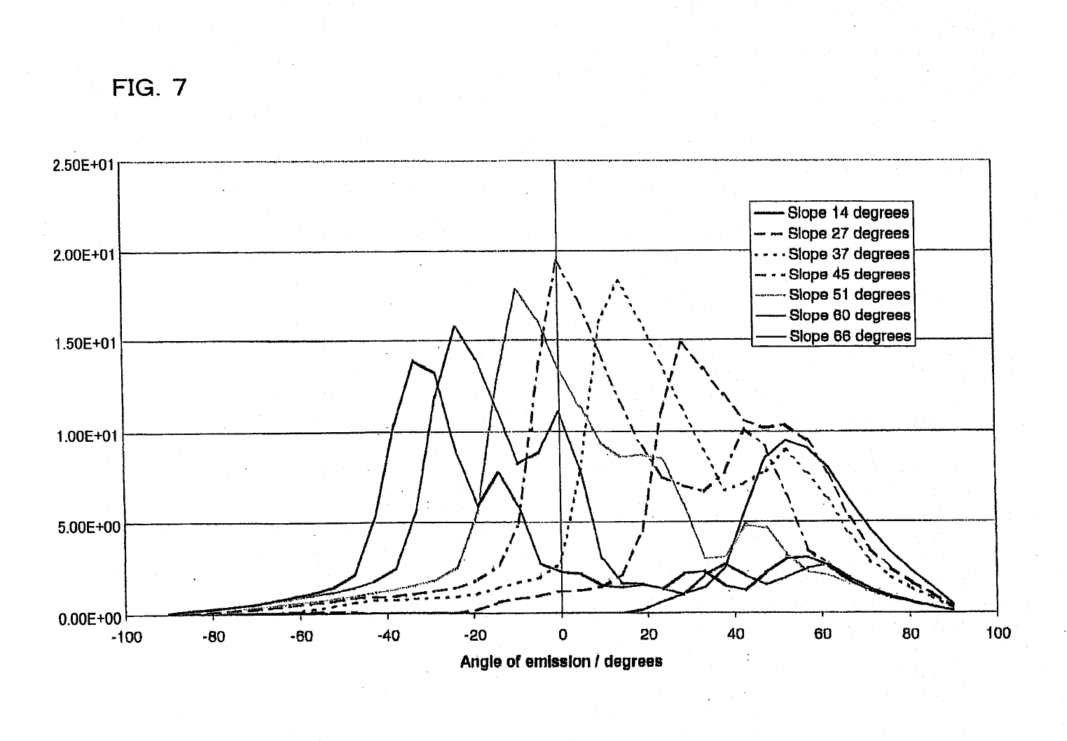

FIG. 7 illustrates the extraction feature performance for different feature slope angles relative to the local tangential plane, which defines the normal direction. As shown in FIG. 3, the slope angles of the extraction features 10 vary across the light guide 4, in particular with distance from the input edge surface 12 through which light is introduced into the light guide 4 from the illuminator 5. In the case of the “concave display” shown in FIG. 3 with the front surface of the light guide 4 being concave and the rear surface being convex, the concave features 10 are such that the slope angle (relative to the local tangential plane) progressively decreases from the features such as 10a near the surface 12 to the features such as 10b remote from the surface 12. In the embodiment shown in FIG. 3, the slope angle decreases progressively with distance from the surface 12. However, the slope angle may vary in a step-wise manner with groups of adjacent features having the same slope angle but with the slope angles of the groups progressively decreasing with distance from the surface 12.

As mentioned above, the distribution of the features 10 is selected so as to achieve a relatively uniform light output, or any other desired light distribution, from the light guide 4. For example, the surface density (number of features per unit area) may increase with distance from the surface 12.

The slope angles of the surfaces 11 of the extraction features 10 are selected so as to achieve the desired angular spread of light from the light guide 4. For example, the slope angles may be selected so as to concentrate light output in a direction normal to the tangent to the image displaying surface at the middle of the display so as to provide maximum brightness for on-axis viewing. Thus, light is concentrated into this “display normal” direction despite the fact that the local normal (relative to the local tangential plane) varies in direction with respect to the display normal. For example, in the case of a typical 2.6 inch display with a one dimensional 200 millimetre radius of curvature, the slope angles of the features may vary between approximately 39° and approximately 51° from one edge of the display to the other so as to concentrate light in and parallel to the direction of the display normal or viewing axis.

Because of the concentration of light by the light guide 4 into the desired viewing angle range for the display, the diffuser 7 need not be as strong as in known displays of the type shown in FIG. 1. Also, no brightness enhancement is required in the plane of FIG. 3 so that no enhancement film is needed for this function. The single enhancement film 8 provides control of angular spreading of light in a plane perpendicular to the plane of FIG. 3.

It is thus possible to provide a non-flat display of good viewing performance. In particular, light can be concentrated into the desired viewing direction so as to provide a relatively bright image display. A relatively weak diffuser is sufficient so that light efficiency is improved and only one enhancement film is needed so that a thinner and cheaper display can be provided.

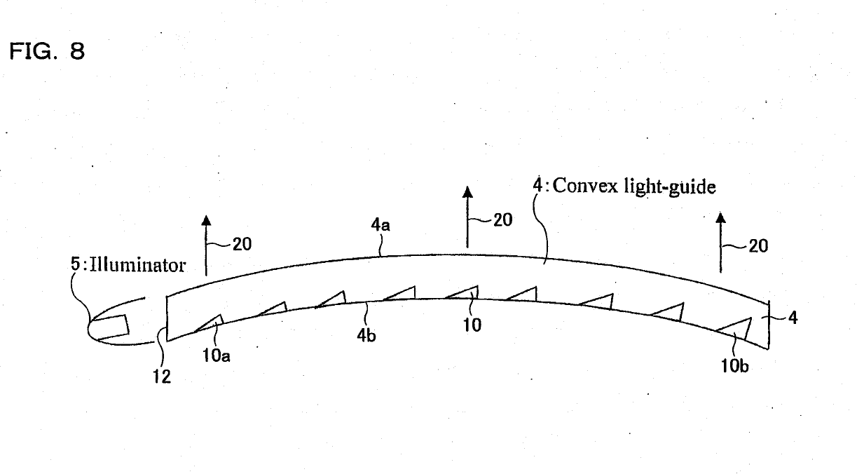

FIG. 8 illustrates a convex light guide 4 which may be used with a convex display in which all of the “concave” elements shown in FIG. 3 are replaced by corresponding “convex” elements. Thus, such a display provides a convex image plane when viewed from the normal viewing direction in front of the display.

The convex light guide 4 has a convex front surface 4a and a concave rear surface 4b. The concave extraction features 10 are provided in the rear surface 4b of the convex light guide in the same way as for the concave light guide. However, these features differ in that the slope angle increases from features such as 10a near the input surface 12 to features such as 10b remote from the surface 12. The distribution of the features may again be such as to provide relatively uniform light output across the waveguide front surface 4a and the slope angles are selected so as to direct light primarily parallel to the display normal or axis, as indicated by the arrows 20.

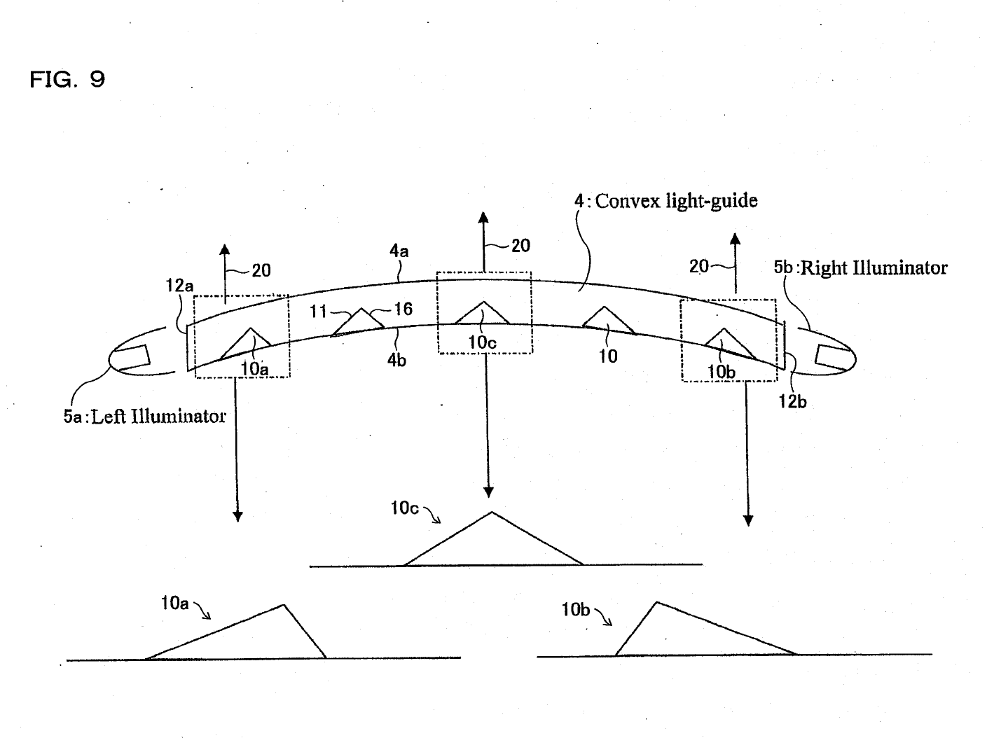

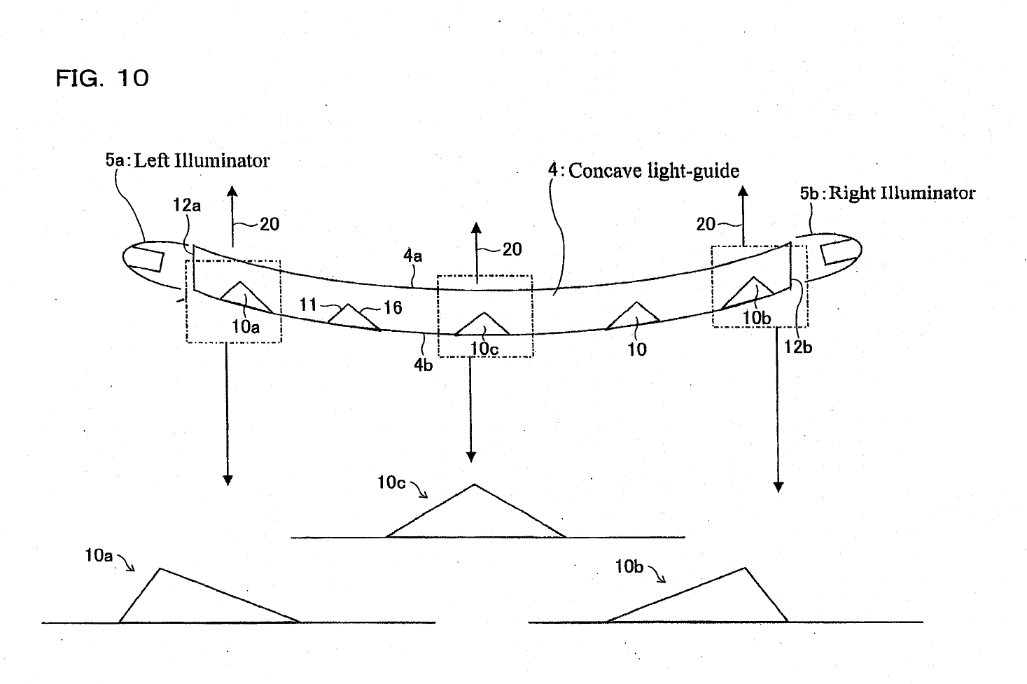

The illuminator 5 may be elongate and may extend along one of the edges of the light guide 4. For example, such an illuminator may comprise a cold cathode florescent lamp and a reflector. As an alternative, the illuminator 5 may comprise a plurality of small light sources, such as light emitting diodes, spaced along the edge. In some applications, it is acceptable to provide the illuminator along only one edge of the display. However, in other applications, it may be necessary or desirable to provide illumination along more than one edge of the light guide 4. For example, illuminators 5a and 5b may be provided along opposite edge surfaces 12a and 12b of a light guide as illustrated in FIGS. 9 and 10.

FIG. 9 illustrates the case of a convex light guide 4. In this case, each of the concave extraction features 10 has a first surface 11 for directing light from the “left” illuminator 5a out of the light guide and a second surface 16 for directing light from the “right” illuminator 5b out of the light guide. FIG. 9 shows in more detail the extraction features 10a, 10b and 10c at the left, right, and middle portions of the light guide 4 so as to illustrate more clearly the relative slope angles. Thus, the slope angles of the surfaces 11 increase with distance away from the input surface 12a whereas the slope angles of the surfaces 16 increase with distance away from the input surface 12b. The variations in slope angles of both of the surfaces 11 and 16 of each extraction feature 10 are such as to direct light across the front surface 4a of the light guide 4 in a relatively narrow angular spread about the display normal or axis.

In the case of the concave light guide 4 shown in FIG. 10, the slope angles of the surfaces 11 decrease from the input surface 12a to the input surface 12b whereas the slope angles of the surfaces 16 decrease from the surface 12b to the surface 12a. For a feature 10c at the middle of the curve of the light guide 4, the slope angles of the surfaces 11 and 16 are the same. In fact, the slope angles may be the same as those for the feature 10c in the convex light guide shown in FIG. 9.

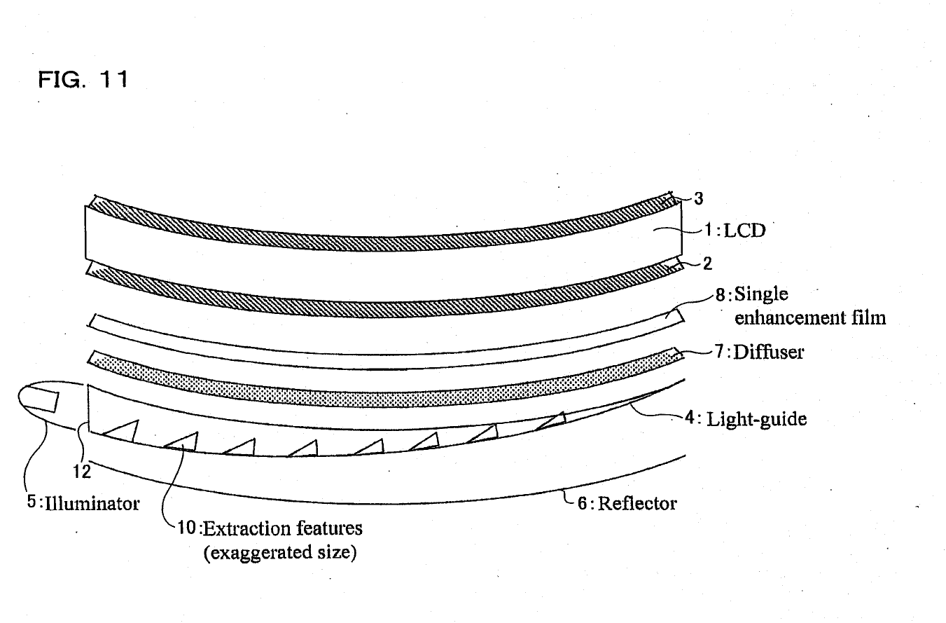

The light guide 4 shown in FIG. 3 is of the “slab” type in that it is of substantially constant thickness. However, a tapered light guide may be used and an example of this is illustrated in FIG. 11 for a concave display. The thickness of the light guide 4 tapers such that it is progressively reduced from its thickest part at the input surface 12 to its thinnest part at the edge remote from the surface 12.

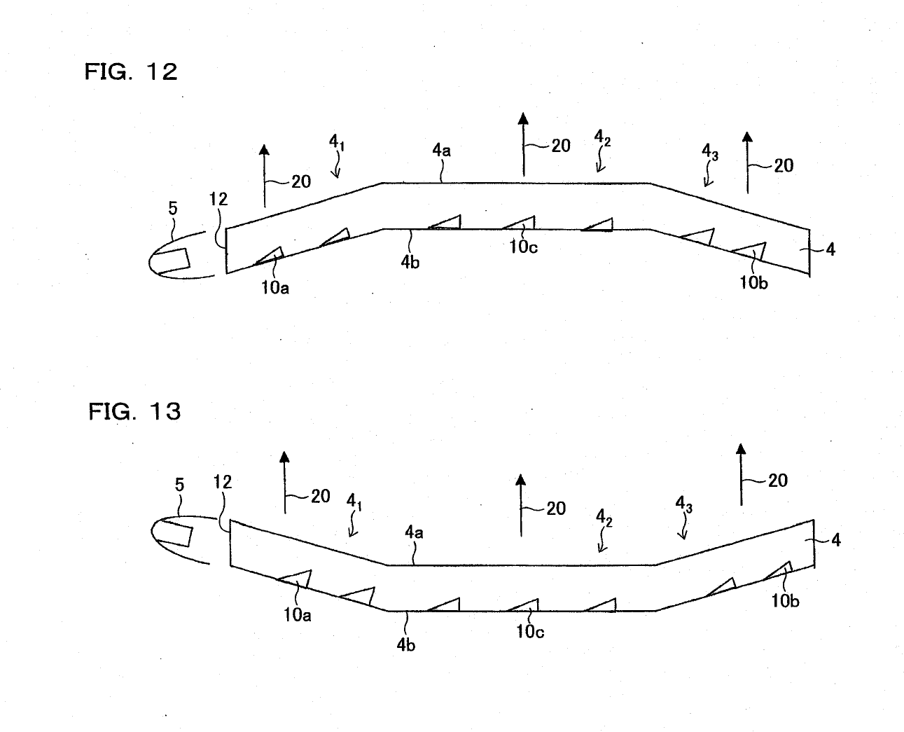

In the embodiments described hereinbefore, the light guide 4 comprises a single section which is cylindrically convex or concave so as to correspond the shape of the LCD 1. However, other non-flat shapes comprising a plurality of sections are possible for the display and the light guide may be shaped appropriately. Examples of other shapes are illustrated in FIGS. 12 to 16.

FIG. 12 illustrates a “convex” light guide 4 comprising three flat sections 4₁, 4₂ and 4₃. The extraction features 10a of the first section 4₁ may have the same slope angle or may have a slope angle which varies with distance from the input surface 12. The features 10c of the second section 4₂ have a larger slope angle than the features 10a and may have the same slope angle or a slope angle which varies across the section 4₂. The features 10b of the third section 4₃ have a larger slope angle than the features 10c and may have the same slope angle or a slope angle which varies across the section.

FIG. 13 illustrates a “concave” light guide 4 which also comprises first, second and third sections 4₁, 4₂ and 4₃, each of which is flat. The features 10a of the first section 4₁ may have the same slope angle or a slope angle which varies across the section. The features 10c of the second section 4₂ have a smaller slope angle than the features 10a and may have the same slope angle or a slope angle which varies across the section. The features 10b of the third section 4₃ have a slope angle which is smaller than the features 10c and which may be the same or may vary across the section.

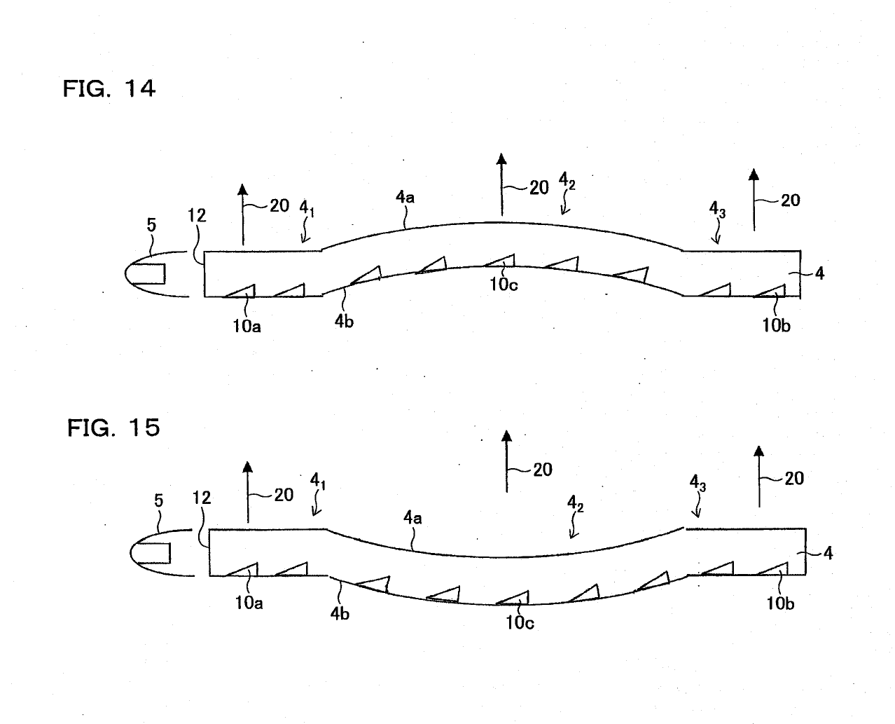

FIG. 14 illustrates a light guide 4 having a first flat section 4₁, a second convex section 4₂ and a third flat section 4₃. The features 10a of the first section 4₁ may have the same slope angle or a slope angle which varies across the section. The features 10c of the second section 4₂ have slope angles which increase with distance from the input surface 12. The feature 10c at the middle of the section 4₂ typically has an angle which is substantially the same as the slope angles of the features 10a. The features 10b of the third section 4₃ may have the same slope angle as each other and as the slope angles of the features 10a or may have slope angles which vary across the section.

FIG. 15 illustrates a “concave” equivalent of the light guide 4 shown in FIG. 14. The light guide 4 of FIG. 15 thus differs from that of FIG. 14 in that the second section 4₂ is concave and has features 10c with a slope angle which decreases with distance from the input surface 12. The slope angles of the features 10a and 10b may be substantially equal to each other and equal to the slope angle of the feature at the middle of the section 4₂.

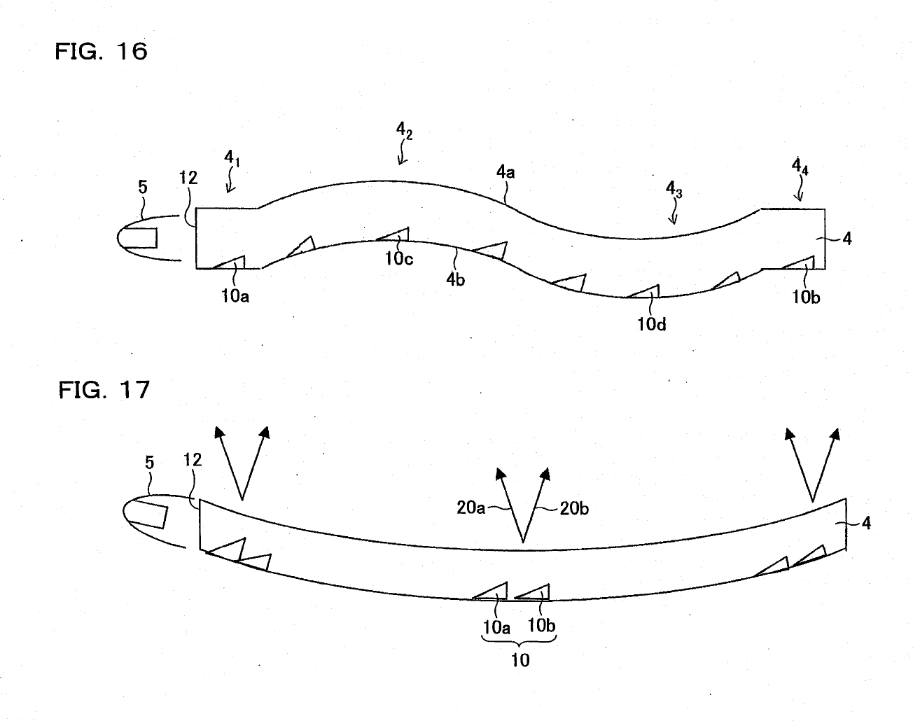

The light guide 4 shown in FIG. 16 is of generally S-shaped cross-section and comprises a first small flat edge section 4₁, a second convex section 4₂ a third concave section 4₃ and a fourth small flat edge section 4₄. The edge sections 4₁ and 4₄ have features 10a and 10b which have the same or similar slope angles, which may also be the same as or similar to the slope angles of features 10c and 10d at the middle of the second and third sections 4₂ and 4₃. The features of the second section 4₂ have slope angles which increase with distances from the input surface 12 whereas the features of the third section 4₃ have slope angles which decrease with distance from the surface 12.

As described hereinbefore, the features 10 are arranged so that the light which is output by the lightguide 4 is concentrated into, a relatively small angular range in a single direction, namely in the direction of the viewing axis of the display. However, the features 10 may be arranged such that there is more than one angular range or direction into which light is concentrated. For example, such a lightguide may be used in a backlight for displays providing different views of different images in different directions. Such a display may be used as an autosteroscopic display for displaying two (or more) stereoscopic views which are required to be visible to the two eyes of an observer to provide a 3D effect. Other applications include multiple view displays, where independent images are required to be seen by viewers in different viewing positions. For example, a vehicle dual view display may be provided in a vehicle and arranged to make different images or sequences of images visible to a driver and a passenger. In such an application, the viewers are disposed away from the display axis.

Any of the lightguides disclosed hereinbefore may be modified or arranged to concentrate light into two or more different directions and FIG. 17 illustrates an example where the lightguide 4 shown in FIG. 3 is modified for this purpose. In this case, the features 10 are arranged as two groups which are distributed across the lightguide 4. The features such as 10a of one of the groups have a slope angle such as to cause light to leave the lightguide 4 in the direction 20a whereas the features such as 10b of the other group cause light to leave the lightguide in the direction 20b. The extraction features 10a and 10b of the two groups have slope angles which vary across the lightguide 4 so as to concentrate the output light in the two directions 20a and 20b. Although these directions are shown as being angled to either side of the viewing or display axis, one of these directions may be parallel to the axis and the other may be at an angle thereto. Also, more than two groups may be provided to direct light in more than two different directions.

1. A backlight for an at least partially transmissive spatial light modulator, comprising at least one first light source and a non-flat light guide having a front major surface for outputting light, a rear major surface, and a first minor surface for inputting light from the at least one first light source, the front surface being non-flat in that it is non-planar such that it cannot be contained in a single plane, at least one of the front and rear surfaces having a plurality of concave features, each of which is defined by a plurality of surfaces extending into the light guide from the major surface, each concave feature of a first set thereof having a first substantially flat surface facing the first minor surface and having a first slope angle, with respect to a tangent plane to the major surface at the feature, oriented to reflect light originating from the at least one first light source out of the light guide, at least one feature of the first set having a first slope angle which is different from that of at least one other feature of the first set.

2. A backlight as claimed in claim 1, in which the rear surface has at least some of the features.

3. A backlight as claimed in claim 2, in which the rear surface has all of the features.

4. A backlight as claimed in claim 2, in which the first surfaces of the features of the rear surface are oriented to reflect the light towards and through the front surface.

5. A backlight as claimed in claim 1, in which the at least one feature and the at least one other feature are at different distances from the first minor surface.

6. A backlight as claimed in claim 1, in which the tangent planes at the at least one feature and at the at least one other feature are non-parallel.

7. A backlight as claimed in claim 1, in which the first slope angles are arranged to reduce the angular spread of light leaving the front surface.

8. A backlight as claimed in claim 1, in which the rear surface is substantially totally internally reflecting for most of the light originating from the at least one first light source.

9. A backlight as claimed in claim 1, in which the light guide has at least one first section whose front surface is concave and whose rear surface is convex.

10. A backlight as claimed in claim 9, in which the front and rear surfaces of the at least one first section are cylindrical.

11. A backlight as claimed in claim 9, in which the at least one other feature is further from the first minor surface and has a smaller first slope angle than the at least one feature.

12. A backlight as claimed in claim 1, in which the light guide has at least one second section whose front surface is convex and whose rear surface is concave.

13. A backlight as claimed in claim 12, in which the front and rear surfaces of the at least one second section are cylindrical.

14. A backlight as claimed in claim 12, in which the at least one other feature is further from the first minor surface and has a larger first slope angle than the at least one feature.

15. A backlight as claimed in claim 1, in which the light guide has at least one third flat section.

16. A backlight as claimed in claim 1, in which the first slope angle varies with feature distance from the first minor surface.

17. A backlight as claimed in claim 1, in which the concave features are arranged to direct light leaving the light guide in substantially the same direction with respect to the light guide.

18. A backlight as claimed in claim 1, in which the concave features are arranged as first and second groups distributed across the light guide and arranged to direct light leaving the light guide substantially in first and second different directions, respectively, with respect to the light guide.

19. A backlight as claimed in claim 1, in which the light guide is of substantially constant thickness.

20. A backlight as claimed in claim 1, in which the light guide has a thickness which reduces with distance from the first minor surface.

21. A backlight as claimed in claim 1, comprising at least one second light source, the light guide having a second minor surface for inputting light from the at least one second light source.

22. A backlight as claimed in claim 21, in which the first and second minor surfaces comprise facing edge surfaces of the light guide.

23. A backlight as claimed in claim 21, in which each of a second set of the features has a second substantially flat surface facing the second minor surface and having a second slope angle, with respect to the tangent plane to the major surface at the feature, oriented to reflect light originating from the at least one light source out of the light guide, at least one feature of the second set having a second slope angle which is different from that of at least one other feature of the second set.

24. A backlight as claimed in claim 23, in which the at least one feature and the at least one other feature of the second set are at different distances from the second minor surface.

25. A backlight as claimed in claim 23, in which the tangent planes at the at least one feature and the at least one other feature of the second set are non-parallel.

26. A backlight as claimed in claim 23, in which the second slope angles are arranged to reduce the angular spread of light leaving the front surface.

27. A backlight as claimed in claim 23, in which the light guide has at least one first section whose front surface is concave and whose rear surface is convex and the at least one other feature of the second set is further from the second minor surface and has a smaller second slope angle than the at least one feature of the second set.

28. A backlight as claimed in claim 23, in which the light guide has at least one second section whose front surface is convex and whose rear surface is concave and the at least one other feature of the second set is further from the second minor surface and has a larger second slope angle than the at least one feature of the second set.

29. A backlight as claimed in claim 23, in which the second slope angle varies with feature distance from the second minor surface.

30. A backlight as claimed in claim 23, in which the second set comprises all of the features.

31. A backlight as claimed in claim 1, in which the first set comprises all of the features.

32. A backlight as claimed in claim 1, in which the features have the same footprints in the major surface.

33. A backlight as claimed in claim 1, in which the surface density of the first surfaces increases with distance from the first minor surface.

34. A backlight as claimed in claim 23, in which the surface density of the second surfaces increases with distance from the second minor surface.

35. A display comprising a backlight as claimed in claim 1 and an at least partially transmissive spatial light modulator.

36. A display as claimed in claim 35, in which the modulator is a liquid crystal device.

37. A display as claimed in claim 35, comprising a single brightness enhancing film disposed between the backlight and the modulator.
